(19) United States
(12) Patent Application Publication
(10) Pub. No.: US 2025/0276922 A1
(43) Pub. Date: Sep. 4, 2025

(54) CATIONIC COAGULANT AND FLOCCULANT COMPOSITIONS AND METHODS OF USE TO REMOVE ORGANICS/INORGANICS FROM PRODUCED WATER AT HIGH TEMPERATURE OPERATIONS

(71) Applicant: ChampionX LLC, Sugar Land, TX (US)

(72) Inventors: Dingzheng Yang, Edmonton (CA); Song Gao, Calgary (CA); Adam Joseph Coulterman, Alberta (CA)

(21) Appl. No.: 19/066,702

(22) Filed: Feb. 28, 2025

Related U.S. Application Data
(60) Provisional application No. 63/560,044, filed on Mar. 1, 2024.

(51) Int. Cl. C02F 1/56; C02F 1/52; C02F 5/06

(52) U.S. Cl. CPC C02F 1/56; C02F 1/5209; C02F 1/5263; C02F 1/529; C02F 5/06; C02F 2303/22

(57) ABSTRACT

Compositions and methods for mitigating organic and inorganic contaminants in produced water prior to lime softening in a steam-assisted gravity drainage facilities (SAGD) are disclosed. In particular methods wherein starch-based coagulants and/or flocculants are added to produced water prior to warm lime softening in a SAGD facility are disclosed.

### CROSS-REFERENCE TO RELATED APPLICATIONS

This application claims priority under 35 U.S.C. § 119 to provisional application Ser. No. 63/560,044, filed Mar. 1, 2024, herein incorporated by reference in its entirety.

### TECHNICAL FIELD

This disclosure relates generally to compositions and methods for mitigating organic and inorganic contaminants in produced water prior to lime softening in a steam-assisted gravity drainage facilities (SAGD). Specifically, described herein are methods wherein starch-based coagulants and/or flocculants are added to produced water prior to warm lime softening in a SAGD facility.

### BACKGROUND

The background description provided herein gives context for the present disclosure.

Hot or warm lime softening is a challenging and costly operation during water treatment in oil sands steam-assisted gravity drainage facilities (SAGD). Hot/warm lime water softening processes have been widely used to remove organic and inorganics from the produced water. Water-soluble organics, such as emulsified oil and free oil, can foul downstream equipment, such as a boiler or the steam generator. Inorganics like calcium, magnesium, and silica can build up scales in said downstream equipment. Standard hot/warm lime softening treatments add limewater (calcium hydroxide or calcium oxide) to remove water hardness (deposits of calcium and magnesium salts) by precipitation. However, depending on the geological formation, hardness and alkalinity of the feed, and pH of the water, it remains a challenge to effectively remove organic and inorganic matter from produced water. Furthermore, hot/warm lime water softening processes are costly, in part due to the amount of coagulant chemistry required.

It is an object of the present disclosure to provide a method wherein one or more coagulant and/or flocculant polymers are added to a produced water prior to lime softening for improved removal of organic and/or inorganics. It is a further object of the present disclosure to improve the removal of organic and/or inorganics without increased cost, or with a reduction in the associated costs.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

Disclosed here in are methods of treating produced water in a Steam Assisted Gravity Drainage facility comprising combining a coagulant composition with a produced water in a Steam Assisted Gravity Drainage prior to lime softening, forming precipitated solids within the produced water. The coagulant composition comprises a cationic coagulant polymer comprising at least one of (i) an unreacted polysaccharide component, (ii) a cationic polysaccharide component reacted with a hydrophilic or hydrophobic component, (iii) a tannin, and/or (iv) a chitosan, at least one additional coagulant comprising an inorganic coagulant and/or an organic coagulant, and a solvent.

In some embodiments, the polysaccharide component is a starch, alginate, cellulose, dextrin, guar, xanthan, and/or any derivatives thereof. In some embodiments, the starch is at least one of a corn starch, potato starch, tapioca starch, sago starch, rice starch, wheat starch, waxy maize starch, grain sorghum starch, grain starch, plant starch or combination thereof. In some embodiments, the inorganic coagulant comprises aluminum or iron salts, and/or wherein the organic coagulant comprises polyamines, polyquaternized polymers, poly(diallylmethyl ammonium chloride (polyDADMAC), EPIDMA, or combinations thereof. In some embodiments, the solvent comprises water.

In some embodiments, the cationic coagulant polymer comprises from about 10 wt-% to about 99 wt-% of the composition, the at least one additional coagulant comprises from about 1 wt-% to about 90 wt-% of the composition, and the solvent comprises from about 1 wt-% to about 90 wt-% of the composition.

In some embodiments, the coagulant composition further comprises a flocculant comprising an anionic and/or nonionic emulsion polymers. In some embodiments, the flocculant is an acrylamide copolymer, polyacrylate and/or a modified polyacrylate.

In some embodiments, the methods further comprise filtering the precipitated solids to form a treated water.

In some embodiments, the coagulant composition is added to the produced water in a concentration of up to about 500 ppm, up to about 250 ppm, up to about 100 ppm, up to about 75 ppm, or up to about 50 ppm; or added to the produced water in a concentration of at least about 10 ppm to about 500 ppm, or at least about 10 ppm to about 100 ppm.

In some embodiments, the method further comprises combining the produced water with calcium hydroxide, magnesium oxide, sodium carbonate, and/or sodium hydroxide. In some embodiments, the lime softening is warm lime softening or hot lime softening.

In some embodiments, the produced water is de-oiled prior to combining with the composition.

In some embodiments, the produced water has a pH of from about 8 to about 9.5.

In some embodiments, turbidity of the produced water after lime softening and removal of the precipitated solids within the produced water is less than about 50 NTU, less than about 25 NTU, or less than about 10 NTU. In some embodiments, turbidity of the produced water after lime softening and removal of the precipitated solids within the produced water is less than the turbidity achieved by a control coagulant composition at equivalent dosing. In some embodiments, turbidity of the produced water after lime softening and removal of the precipitated solids within the produced water is less than or equal to the turbidity achieved by a control coagulant at a dosing concentration that is at least 10 ppm, at least 20 ppm, at least 30 ppm, or at least 40 ppm less than the control coagulant composition. In some embodiments, the control coagulant composition comprises one of epichlorohydrin dimethyl amine copolymer or dimethylaminoethyl acrylate and one of a polyacrylate or acrylate-acrylamide copolymer flocculant

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive

### BRIEF DESCRIPTION OF THE DRAWINGS

FIG. 1 is a schematic of a general process for treating produced water in Steam-Assisted Gravity Drainage (SAGD).

FIG. 2 shows a schematic diagram of a typical SAGD process.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and urcido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are commonly used aryls. The term “aryl” also includes heteroaryl.

“Arylalkyl” means an aryl group attached to the parent molecule through an alkylene group. In some embodiments the number of carbon atoms in the aryl group and the alkylene group is selected such that there is a total of about 6 to about 18 carbon atoms in the arylalkyl group. A commonly used arylalkyl group is benzyl.

As used herein, the term “between” is inclusive of any endpoints noted relative to a described range. When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

The term “-ene” as used as a suffix as part of another group denotes a bivalent substituent in which a hydrogen atom is removed from each of two terminal carbons of the group, or if the group is cyclic, from each of two different carbon atoms in the ring. For example, alkylene denotes a bivalent alkyl group such as methylene (—CH₂—) or ethylene (—CH₂CH₂—), and arylene denotes a bivalent aryl group such as o-phenylene, m-phenylene, or p-phenylene.

As used herein, the term “exemplary” refers to an example, an instance, or an illustration, and does not indicate a most preferred embodiment unless otherwise stated.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “generally” encompasses both “about” and “substantially.”

As used herein, the term “optional” or “optionally” means that the subsequently described component, event or circumstance may but need not be present or occur. The description therefore discloses and includes instances in which the event or circumstance occurs and instances in which it does not, or instances in which the described component is present and instances in which it is not.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The term “turbidity” as used herein, refers to a measurement of water clarity. Turbidity is measured according to the amount of light that passes through a sample, where a clear sample has low turbidity and murkier sample has higher turbidity. The more the light is scattered or blocked during testing the higher the turbidity according to the unit of measurement NTU or Nephelometric Turbidity Unit (NTU).

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

Disclosed herein are methods for treating produced water in a Steam Assisted Gravity Drainage (SAGD) facility that comprise combining a coagulant composition with produced water prior to lime softening. The methods and compositions described herein beneficially result in a produced water with reduced turbidity. Other benefits may include improving effluent water quality and/or reducing the sludge content of the water.

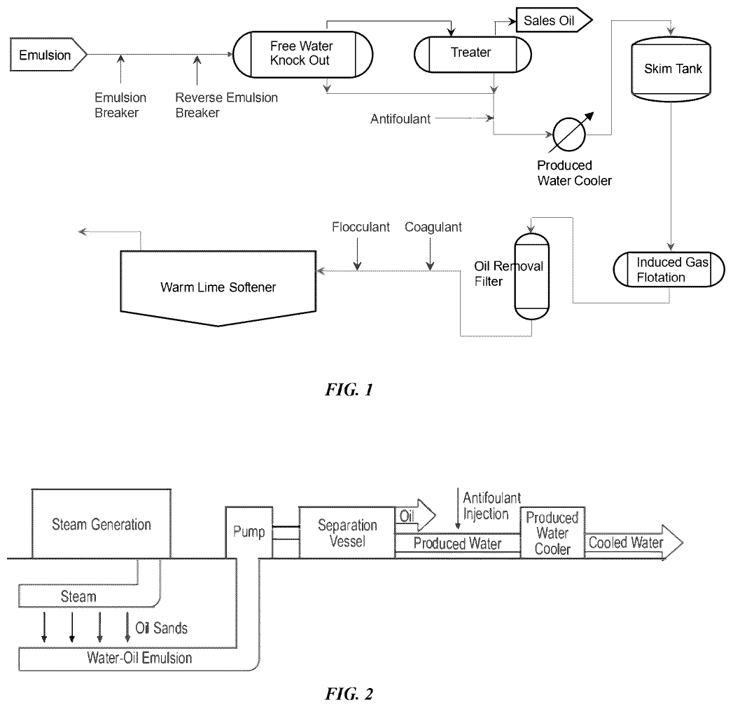

A schematic for an exemplary basic SAGD system is shown in FIG. 2. In an exemplary SAGD system, oil is recovered through a pair of horizontal wells. Steam is injected into a top well, reducing the viscosity of bitumen which flows to the lower well. A production fluid emulsion is recovered. The production fluid is then sent through separation vessels to separate the oil from the produced water. Once separated, the oil is sent for further processing and the produced water is sent through one or more produced water coolers. The cooled water, or a portion thereof, can then be reused for steam and/or sent for more processing, for example softening. A more detailed schematic for an exemplary basic system of treating the production fluid is shown in FIG. 1. The production fluid (labeled “Emulsion”) comprising bitumen and water in a complex emulsion is injected with emulsion and reverse emulsion chemistries and sent through one or more separation vessels to separate the oil from the produced water (“Free Water Knock Out”). Once separated, the oil is sent for further processing (“Treater”) and, likewise the produced water is sent for further processing (“Produced Water Cooler,” “Skim Tank,” “Induced Gas Flotation,” “Oil Removal Filter,” “Warm Lime Softener”). The cooled and treated water, or a portion thereof, can then be reused for steam and/or other purposes. In the methods described herein, a flocculant and/or coagulant are injected into the produced water prior to lime softening.

Disclosed herein is a method of treating produced water in a SAGD facility comprising combining a coagulant composition with a produced water in a SAGD facility prior to lime softening and forming precipitated solids within the produced water. As used herein, lime softening refers to a process wherein lime compositions are added to water to remove hardness (e.g. calcium and magnesium salts) by precipitation. In SAGD processes, warm or hot lime softening systems are often used. Warm lime softening operates in a temperature range of up to about 60° C., or up to about 90° C., where the solubilities of calcium, magnesium, silica and the like are reduced with the increased temperature. Hot lime softening operates at a temperature above 90° C., or above 100° C., often under pressure. Both warm and hot lime softening processes are costly and challenging.

In the methods described herein, the coagulant composition is combined with produced water prior to lime softening. That is meant to embody any time prior to lime softening after the separation vessel. In an embodiment, the coagulant composition is combined with the produced water upstream of the lime softening. In an embodiment, the coagulant composition is combined with the produced water in the softening vessel, prior to lime softening. In an embodiment, the coagulant composition is combined with the produced water at the inlet to the softening vessel, prior to lime softening. In an embodiment, the coagulant composition is combined with the produced water after the water has been de-oiled and/or processed through an oil removal filter.

The coagulant composition comprises a coagulant polymer component comprising at least one of (i) an unreacted polysaccharide component, (ii) a cationic polysaccharide component, preferably a natural cationic polysaccharide component, which is reacted with a hydrophilic or hydrophobic component, (iii) a tannin, and/or (iv) a chitosan. In embodiments, the composition further comprises at least one additional coagulant comprising an inorganic coagulant and/or an organic coagulant and a solvent.

The polysaccharide can include an unreacted polysaccharide component and/or a cationic polysaccharide component reacted with a hydrophilic or hydrophobic component. In preferred embodiments the polysaccharide is a cationic polysaccharide component, more preferred the cationic polysaccharide component is reacted with a hydrophilic or hydrophobic component.

It will be understood that as used herein the terms “unreacted polysaccharide component”, “polysaccharide reacted with a hydrophilic component”, and “polysaccharide reacted with a hydrophobic component” may refer to regions of the same polysaccharide molecule. For example, an unreacted polysaccharide component may comprise a region of a polysaccharide molecule that is unreacted with one or more hydrophilic and/or hydrophobic reagent. As disclosed in U.S. Pat. No. 11,174,374, an unmodified polysaccharide preparation may be reacted with one or more hydrophilic and/or hydrophobic reagent, resulting in regions of the polysaccharide which are substituted with a hydrophilic moiety and/or a hydrophobic moiety, and regions which may remain unsubstituted.

Hydrophilic components may include for example, quaternary ammonium reagents which confer a positive charge on the molecule with which they react. Exemplary quaternary ammonium reagents may include, without limitation, hydroxides and halides of tetramethyl ammonium, tetraethyl ammonium, tetrabutyl ammonium, and benzyl trimethyl ammonium and mixtures thereof. One currently preferred hydrophilic component is a 65% (by weight) solution of 1-propanaminium, 3-chloro-2-hydroxy-N,N,N-trimethylchloride sold by Dow Hampshire Chemical Corp. under the tradename Quat 188. However, those of ordinary skill in the art are aware that other commercially available hydrophilic reagent components are readily available and can be used to confer a positive charge, a negative charge, or a polar property upon a polysaccharide, provided that such component or components are effective as a hydrophilic component in accordance with the uses described herein.

Hydrophobic components may include for example, olefin oxides such as, without limitation, styrene oxide, ethylene oxide, polyethylene oxide, and aliphatic olefin oxides having, for example, chain lengths of between 10 to 16 carbons, and mixtures thereof. Other commercially available hydrophobic reagent components can be employed provided that such component or components are effective as a hydrophobic component in accordance with the uses described herein.

Combination of hydrophilic and hydrophobic components can be combined to provide amphiphilic component or moieties including for example, quaternary ammonium agents comprising a hydrophobic substitution which have both a hydrophobic moiety and a cationic quaternary ammonium component. One useful amphiphilic component is a 38% (by weight) solution of 3-chloro-2-hydroxypropyl-lauryl-dimethylammonium chloride sold by SKW Quab Chemicals, Inc. under the tradename Quab 342. Additional quabs may include Quab 360 (3-chloro-2-hydroxypropyl-cocoalkyl-dimethylammonium chloride) and Quab 426 (3-chloro-2-hydroxypropyl-stearyl-dimethylammonium chloride), in which the lauryl moiety of Quab 342 is substituted with cocoalkyl and stearyl groups, respectively. A characteristic of these reagents is that they confer a positive charge by virtue of the quaternary ammonium moiety, and a hydrophobic region by virtue of the aliphatic substitution.

In embodiments, a polysaccharide molecule may comprise a degree of substitution with a hydrophobic component great enough effective to increase the oil solubility of the polysaccharide molecule. It will be understood that in certain cases the hydrophilic component and the hydrophobic component may be comprised in a single compound, such as an amphiphilic moiety. In one example, the coagulant composition has a sufficient hydrophilic/hydrophobic balance to be effective in use as described herein.

In various embodiments where the coagulant composition comprises a polysaccharide component, this can include a starch, alginate, cellulose, dextrin, guar, xanthan, and/or any derivatives thereof. Starches are large polycarbohydrates (polysaccharides) comprising glucose units linked by glycoside bonds. In pure starch, there are two types of molecules, linear and helical amyloses, and amylopectin, which is a branched molecule. These are usually present, depending upon the source, in from about 20% to about 25% amylose and from about 75% to about 80% amylopectin. In embodiments, the starch is at least one of a corn starch, potato starch, tapioca starch, sago starch, rice starch, wheat starch, waxy maize starch, grain sorghum starch, grain starch, plant starch or combination thereof.

Commercially-available examples of the natural cationic polysaccharide components are described in U.S. Pat. No. 11,174,374 as dewatering components and compositions, including the compositions GFT 5100, containing a cationic starch based natural coagulant, which is described as a composition of 78.2 wt % water; 19.3 wt % modified corn starch (100% amylopectin) substituted with Quat® 188; 2.5 wt % NaCl, and GFT 5013, containing a cationic starch based natural coagulant, which is described as a composition of 48.5 wt % water; 42.4 wt % modified corn starch (100% amylopectin) substituted with Quat®188; 9.1 wt % NaCl. The disclosure of this reference is incorporated herein by reference in its entirety for examples of additional polysaccharides for use in the methods as described for components of the coagulant composition.

In further embodiments the coagulant composition can include a tannin. Tannins are a family of polyphenolic compounds containing hydroxyl groups and often carboxyl groups; tannins in general tend to form complexes with proteins and other organic compounds and macromolecules. Tannins are naturally-occurring in various plant species. In addition there are synthetic tannins (synthetic polyphenolic compounds) that are available, such as phenol-formaldehyde based resins, particularly those termed “novolacs” having a formaldehyde to phenol ratio of less than one and cross-linked with methylene or dimethylene bridges.

Generally, tannins occur in three major classes, classified by the monomer unit of the tannin. In one class, the hydrolysable tannins, the monomer comprises a gallic acid monomer unit. The second class, the non-hydrolysable (or condensed) tannins, the monomer unit is flavone. Both of the first tannin classes can be extracted from plants. The third tannin class, the phlorotannins, is extracted from brown algae, and comprises a phlorogluconol subunit. Particularly in the flavone-derived tannins, the monomer is polymerized and further hydroxylated in order to yield the relatively high molecular weight polyphenol motif characteristic of tannins. A tannin must generally have at least about 12 hydroxyl groups and at least about five phenyl groups to bind proteins substantially. Tannins are generally completely water-soluble. Tannins may have molecular weights ranging from about 500 Da to over 20,000 Da.

In further embodiments the coagulant composition can include a chitosan. Chitosan is a natural oligosaccharide (a type of polysaccharide) that can be used for flocculant and/or coagulant benefits. “Oligosaccharides” are glycan structures that are composed of three or more monosaccharide subunits that are linked to each other via glycosidic bonds in a linear or in a branched structure. “Oligosaccharide” as the term is used herein refers to a saccharide polymer containing a small number, typically three to twenty, of simple sugars, i.e., monosaccharides. Chitosan polysaccharides can be further reacted and available in a wide range of molecular weights and are generally ranging from about 50 Da to about 2,000 Da.

In addition to the polysaccharide, tannin, and/or chitosan, the coagulant composition includes at least one additional coagulant. In embodiments the additional coagulant comprises an inorganic coagulant and/or an organic coagulant. Exemplary inorganic coagulants include for example, aluminum or iron salts, such as without limitation, one or more of aluminum sulfate, aluminum choride, aluminum chlorohydrate, sodium aluminate, polyaluminum chloride, polyaluminum sulfur chloride, polyaluminum silicate chloride, one or more of ferric sulfate, ferrous sulfate, ferric chloride, ferric chloride sulfate, polyferric sulfate, and forms of any of these salts in conjunction with organic polymers. Exemplary organic coagulants include for example, polyamines, polyquaternized polymers, poly(diallylmethyl ammonium chloride (polyDADMAC), epichlorohydrin dimethyl amine copolymer (EPI-DMA) which is a cationic coagulant solution polymer. In embodiments, combinations thereof the inorganic and organic coagulants are envisioned.

Still further the coagulant composition includes a solvent, preferably water as the solvent.

In embodiments the coagulant polymer comprises from about 10 wt-% to about 99 wt-% of the composition, the at least one additional coagulant comprises from about 1 wt-% to about 90 wt-% of the composition, and the solvent comprises from about 1 wt-% to about 90 wt-% of the composition.

In further embodiments the coagulant polymer comprises from about 10 wt-% to about 99 wt-%, from about 10 wt-% to about 95 wt-%, or from about 10 wt-% to about 90 wt-% of the composition, the at least one additional coagulant comprises from about 1 wt-% to about 90 wt-%, from about 1 wt-% to about 80 wt-%, or from about 1 wt-% to about 60 wt-% of the composition, and the solvent comprises from about 1 wt-% to about 90 wt-%, from about 5 wt-% to about 90 wt-%, or from about 10 wt-% to about 90 wt-% of the composition.

The coagulant composition can further include a flocculant comprising anionic and/or nonionic emulsion polymers. Exemplary flocculants include acrylamide copolymers, polyacrylate and/or a modified polyacrylate. The flocculant polymers include water-soluble copolymers, terpolymers, etc. Example water-soluble monomers that can be included as part of the anionic and/or nonionic emulsion polymers include acrylamide, methacrylamide, acrylic acid, alkali metal salts of acrylic acid, methacrylic acid, dimethylaminoethyl methacrylate, vinylbenzyl trimethylammonium chloride, alkali metal and ammonium salts of 2-sulfoethylacrylate, sodium styrene sulfonate, 2-aminoethylmethacrylate hydrochloride, alkali metal and ammonium salts of vinyl benzyl sulfonates and the like. In preferred embodiments the flocculants include acrylamide copolymers, polyacrylate and/or a modified polyacrylate.

In embodiments where a flocculant comprising an anionic and/or nonionic emulsion polymer is included in the coagulant composition, the flocculant comprises from about 1 wt-% to about 90 wt-%, from about 1 wt-% to about 80 wt-%, or from about 1 wt-% to about 60 wt-% of the composition.

In an embodiment, the coagulant composition is added to the produced water at a concentration of up to about 500 ppm, up to about 250 ppm, up to about 100 ppm, up to about 75 ppm, or up to about 50 ppm. In an embodiment, the coagulant composition is added to the produced water at a concentration of from about 10 ppm to about 500 ppm, or from about 10 ppm to about 250 ppm, or from about 10 ppm to about 100 ppm. In an embodiment, the coagulant composition is added to the produced water at a concentration of at least about 10 ppm, at least about 20 ppm, or at least about 50 ppm. In an embodiment, the coagulant composition is added to the produced water of a concentration of at least about 5 ppm to about 1000 ppm, to about 750 ppm, or to about 250 ppm.

In an embodiment, the produced water has a pH of above 7. In an embodiment, the produced water has a pH of from about 8 to about 9.5.

In an embodiment, the method further comprises combining the produced water with calcium hydroxide, magnesium oxide, sodium carbonate, and/or sodium hydroxide during lime softening. In an embodiment, the lime softening is warm softening. In an embodiment, the lime softening is hot softening.

In an embodiment, the methods described herein further comprise filtering the precipitated solids from the water to form a treated water. In an embodiment, the filtering occurs directly after lime softening.

In an embodiment, the methods described herein reduce the turbidity of the produced water after lime softening and removal of the precipitated solids as compared to a control coagulant composition. In an embodiment, the methods described herein reduce the turbidity of the produced water after lime softening and removal of the precipitated solids at a lower dose than a control coagulant composition. In an embodiment, the methods described herein result in a turbidity of the produced water after lime softening and removal of the precipitated solids that is equal or less than the turbidity achieved by a control coagulant composition, at a lower dose than a control coagulant composition. In an embodiment, the turbidity of the produced water after lime softening and removal of the precipitated solids within the produced water is less than or equal to the turbidity achieved by a control coagulant composition when the coagulant composition is dosed at a concentration that is at least 10 ppm, at least 20 ppm, at least 30 ppm, or at least 40 ppm less than the control coagulant composition. In an embodiment, the turbidity of the produced water is less than the turbidity achieved by a control coagulant composition comprising one of epichlorohydrin dimethyl amine copolymer or dimethylaminoethyl acrylate and one of a polyacrylate or acrylate-acrylamide copolymer flocculant at equivalent dosing. In an embodiment, the turbidity of the produced water is less than the turbidity achieved by a control coagulant composition comprising one of epichlorohydrin dimethyl amine copolymer or dimethylaminoethyl acrylate and one of a polyacrylate or acrylate-acrylamide copolymer flocculant at a dosing concentration that is at least 10 ppm, at least 20 ppm, at least 30 ppm, or at least 40 ppm less than the control coagulant composition. The methods disclosed herein beneficially reduce the turbidity of produced water without additional costs by not requiring a higher dosing concentration, and in some embodiments reduce the turbidity of produced water with lower costs by reducing the dosing concentration.

In an embodiment, the turbidity of the produced water after lime softening and removal of the precipitated solids from the produced water is less than about 50 NTU, less than about 25 NTU, less than about 10 NTU, or less than about 5 NTU.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

### Warm Lime Softener Polymer Testing-Jar Tests

Jar testing was performed to assess efficacy of cationic coagulant polymers in comparison to commercially-available controls of industry standards at lower dosages. Efficacy is assessed based on water turbidity and settling rate of sludge in the test procedures. The following coagulants and flocculant products were tested in Table 1.

TABLE 1

| | | |
|---|---|---|
| Coagulant A | Commercial Control Coagulant | |
| | Epichlorohydrin Dimethyl Amine Copolymer | |
| Coagulant B | Commercial Control Coagulant | |
| | Dimethylaminoethyl Acrylate | |
| Coagulant C | Cationic Starch Based Natural | |
| | Coagulant/ACH Blend | |
| Coagulant D | Cationic Starch Based Natural Coagulant | Viscosity: 3000-6000 cp, |
| | | Density: 9.7 lbs/gal |
| Coagulant E | Cationic Starch Based Natural Coagulant | Viscosity: 3000-8000 cp, |
| | | Density: 9.12 lbs/gal |
| Coagulant F | Cationic Starch Based Natural Coagulant | Viscosity: 3000-8000 cp, |
| | | Density: 10 lbs./gal |
| Coagulant G | Cationic Starch Based Natural | |
| | Coagulant/ACH Blend | |
| Coagulant H | Cationic Starch Based Natural Coagulant | Viscosity: 2000-5000 cp, |
| | | Density: 9.7 lbs/gal |
| Coagulant I | Starch Based Natural Coagulant | Viscosity: 700-1000 cp, |
| | | Density: 9.75 lbs/gal |
| Coagulant J | Starch Based Natural Coagulant/ACH Blend | |
| Coagulant K | Starch Based Natural Coagulant/Tannin Blend | |
| Flocculant I | Commercial Control Flocculant | |
| | Polyacrylate | |
| Flocculant II | Commercial Control Flocculant | |
| | Acrylate-Acrylamide Copolymer | |
| Flocculant III | Polyacrylate | |
| Flocculant IV | Polyacrylate | |
| Flocculant V | Polyacrylate | |
| Flocculant VI | Anionic Emulsion | |

Coagulants A and B are commercially-available and utilized control coagulants. Flocculants I and II are commercially-available and utilized control flocculants.

The experimental procedure was as follows: first, between about 1-1.1 liters of a water sample was poured into the testing jar with the overhead mixer. Then, the water was heated to about 80° C. Next, the mixing speed was set to RPM between 300 to 800. Then, lime, MagOx, soda ash, sludge, and other recycled streams were added according to conventional lime softening process. Next, a desired dosage of coagulant and flocculant were added. After 1-5 minutes of mixing, the mixing was stopped, the settling was observed, and the samples were collected for analysis. Tests were completed with sludge and without sludge.

The evaluated chemicals and concentrations are shown in Table 2.

TABLE 2

| | |
|---|---|
| Water Composition | Water Composition |
| (with sludge) | (without sludge) |

| | | | | |
|---|---|---|---|---|
| De-oiled water | 1 | L | 1.1 | L |

| | | |
|---|---|---|
| Recycled Stream | 5% | 5% |
| Sludge added | 10% | 0 |

| | | | | |
|---|---|---|---|---|
| Lime | 150 | ppm | 150 | ppm |
| MagOx | 300 | ppm | 300 | ppm |
| Caustic (50%) | 60 | ppm | 60 | ppm |

| | | |
|---|---|---|
| pH | 9.6 | 9.6 |

Initial testing was completed to assess dosing ranges for flocculant transition and the baseline jar testing and the effects of the coagulant during the transition period and confirmed a threshold turbidity measurement to be set at an improvement over commercially-available control and bench mark performance. In SAGD facilities the turbidity at the WLS outlet is expected to be below 10 NTU although in bench testing this can vary. However, in most instances the turbidity is <50 NTU.

One skilled in the art will appreciate that the turbidity for a product is variable and subject to change based on testing system conditions and methods used. For each testing in the trials described herein, Coagulant A and Flocculant I are included as a commercially-available control and bench mark (shown in Jar 1 for each table in Trials 1-4) as well as Coagulant B and Flocculant I included as a commercially-available control and bench mark (shown in Jar 1 for each table in Trial 5). The results show that the turbidity of Jar 1 (the commercially-available control and bench mark) varies between tests. The comparison in performance of the compositions described according to the invention that show improved turbidity over the Jar 1 bench mark represent an improved performance.

### Trial 1

### Starch Based Products Against Coagulant A

Table 3 shows the results of trial 1, performed to determine the effects of starch-based coagulants D, F, G and K and VI, against Coagulant A on turbidity.

TABLE 3

| Jar | Contents | Turbidity (NTU) |
|---|---|---|
| 1 | 80 ppm coagulant A: 4 ppm flocculant I | 15.5 |
| 2 | 40 ppm coagulant D: 4 ppm flocculant I | 22.5 |
| 3 | 40 ppm coagulant F: 4 ppm flocculant I | 9 |
| 4 | 40 ppm coagulant K: 4 ppm flocculant I | 5.6 |
| 5 | 40 ppm flocculant VI: 4 ppm flocculant I | 36 |
| 6 | 40 ppm coagulant G: 4 ppm flocculant I | 15.3 |

Trial 1 showed flocculant VI settled extremely fast (indicative of effective coagulation) and created clumpy sludge that would fall right out of the glass without any sludge sticking to the glass. Coagulant K settled second fastest and had an excellent turbidity.

The results from Trial 1 show that the benchmark turbidity in Jar 1 is outperformed by Jars 3-4 and 6. Jar 5 showing combination of the two flocculants did not outperform the benchmark demonstrating improvement in reduced ppm only when combining the coagulant and flocculants. The Coagulant D has a medium viscosity range, which may correlate to a medium molecular weight.

### Trial 2

Starch Based Products Against Coagulant a at a Lower Dosage than Trial 1

Table 4 shows the results of trial 2, performed to determine the effects of starch based coagulant D, F, G and K and VI, against coagulant A at a lower dosage than trial 1.

TABLE 4

| Jar | Contents | Turbidity (NTU) |
|---|---|---|
| 1 | 80 ppm Coagulant A: 4 ppm flocculant I | 27.4 |
| 2 | 20 ppm coagulant D: 4 ppm flocculant I | 10.2 |
| 3 | 20 ppm coagulant F: 4 ppm flocculant I | 7 |
| 4 | 20 ppm coagulant K: 4 ppm flocculant I | 26.8 |
| 5 | 20 ppm flocculant VI: 4 ppm flocculant I | 21.7 |
| 6 | 20 ppm coagulant G: 4 ppm flocculant I | 10.2 |

Trial 2 showed all of the products performed well at 20 ppm. The turbidity for all the products were lower than Coagulant A. The results from Trial 2 show that the benchmark turbidity in Jar 1 is outperformed by Jars 2-6.

### Trial 3

### Starch Based Products Against Coagulant a at 10 ppm

Table 5 shows the results of trial 3, performed to determine the effects of starch based coagulant D, F, G and K and VI, at 10 ppm to low end of the dosing that provides suitable turbidity.

TABLE 5

| Jar | Contents | Turbidity (NTU) |
|---|---|---|
| 1 | 80 ppm Coagulant A: 4 ppm flocculant I | 34 |
| 2 | 10 ppm coagulant D: 4 ppm flocculant I | 58 |
| 3 | 10 ppm coagulant F: 4 ppm flocculant I | 63 |
| 4 | 10 ppm coagulant K: 4 ppm flocculant I | 39.7 |
| 5 | 10 ppm flocculant VI: 4 ppm flocculant I | 97 |
| 6 | 10 ppm coagulant G: 4 ppm flocculant I | 20.7 |

Trial 3 showed that at 10 ppm coagulant G had a lower turbidity than Coagulant A at 80 ppm. All the other tested coagulants at 10 ppm were shown to have a higher turbidity as compared to Coagulant A at 80 ppm, demonstrating that an increase in concentration ppm of the coagulants would be required for the current testing conditions, as shown above in Trial 2.

### Trial 4

Evaluation of Flocculants with Consistent Coagulant a Dosage

Table 6 shows the results of trial 4, performed to evaluate the flocculants as compared against flocculant I when using a consistent Coagulant A dosage.

TABLE 6

| Jar | Contents | Turbidity (NTU) |
|---|---|---|
| 1 | 80 ppm Coagulant A: 4 ppm flocculant I | 60.4 |
| 2 | 80 ppm Coagulant A: 4 ppm flocculant II | 36.8 |
| 3 | 80 ppm Coagulant A: 4 ppm flocculant IV | 40.7 |
| 4 | 80 ppm Coagulant A: 4 ppm flocculant V | 40.4 |
| 5 | 80 ppm Coagulant A: 4 ppm flocculant VI | 19.9 |
| 6 | 80 ppm Coagulant A: 4 ppm flocculant III | 19.3 |

Trial 7 showed that during the settling, flocculant VI and III showed the lowest turbidity. All the flocculants showed lower turbidity than flocculant I. The sludge settling rates were faster for flocculant IV and V compared to using other flocculants. Sludge settling rates for flocculant IV and flocculant II were similar.

The results from Trial 4 show that the benchmark turbidity in Jar 1 is outperformed by Jars 2-6 at equal concentrations demonstrating improvements in reducing turbidity and ability to lower the concentration ppm of the coagulant/flocculant for treatment.

### Trial 5

Evaluation of Flocculants with Consistent Coagulant B Dosage

Table 7 shows the results of trial 5, performed to evaluate the flocculants as compared against flocculant I when using a consistent Coagulant B dosage of 25 ppm.

TABLE 7

| Jar | Contents | Turbidity (NTU) |
|---|---|---|
| 1 | 25 ppm Coagulant B: 4 ppm flocculant I | 13.7 |
| 2 | 25 ppm Coagulant B: 4 ppm flocculant II | 7.5 |
| 3 | 25 ppm Coagulant B: 4 ppm flocculant IV | 10.4 |
| 4 | 25 ppm Coagulant B: 4 ppm flocculant V | 11.5 |
| 5 | 25 ppm Coagulant B: 4 ppm flocculant VI | 17.5 |
| 6 | 25 ppm Coagulant B: 4 ppm flocculant III | 7.1 |

Trial 5 showed that flocculant VI no longer exhibited the best turbidity of the trial when used with Coagulant B. Flocculant III showed the lowest turbidity. The results from Trial 5 show that the benchmark turbidity in Jar 1 is outperformed by Jars 2-4 and 6.

The present disclosure is further defined by the following numbered embodiments.
1. A method of treating produced water in a Steam Assisted Gravity Drainage facility comprising combining a coagulant composition with a produced water in a Steam Assisted Gravity Drainage prior to lime softening; and forming precipitated solids within the produced water, wherein the coagulant composition comprises: a coagulant polymer comprising at least one of (i) an unreacted polysaccharide component, (ii) a cationic polysaccharide component reacted with a hydrophilic or hydrophobic component, (iii) a tannin, and/or (iv) a chitosan, at least one additional coagulant comprising an inorganic coagulant and/or an organic coagulant, and a solvent.
2. The method of embodiment 1, wherein the polysaccharide component is a starch, alginate, cellulose, dextrin, guar, xanthan, and/or any derivatives thereof.
3. The method of embodiment 2, wherein the starch is at least one of a corn starch, potato starch, tapioca starch, sago starch, rice starch, wheat starch, waxy maize starch, grain sorghum starch, grain starch, plant starch or combination thereof.
4. The method of any one of embodiments 1-3, wherein the coagulant polymer comprises from about 10 wt-% to about 99 wt-% of the composition, the at least one additional coagulant comprises from about 1 wt-% to about 90 wt-% of the composition, and the solvent comprises from about 1 wt-% to about 90 wt-% of the composition.
5. The method of any one of embodiments 1-4, wherein the inorganic coagulant comprises aluminum or iron salts, and/or wherein the organic coagulant comprises polyamines, polyquaternized polymers, poly(diallylmethyl ammonium chloride (polyDADMAC), EPIDMA, or combinations thereof.
6. The method of any one of embodiments 1-5, wherein the coagulant composition further comprises a flocculant comprising an anionic and/or nonionic emulsion polymers.
7. The method of embodiment 6, wherein the flocculant is an acrylamide copolymer, polyacrylate and/or a modified polyacrylate.
8. The method of any one of embodiments 1-7, wherein the solvent comprises water.
9. The method of any one of embodiments 1-8, wherein the method further comprises filtering the precipitated solids to form a treated water.
10. The method of any one of embodiments 1-9, wherein the composition is added to the produced water in a concentration of up to about 500 ppm, up to about 250 ppm, up to about 100 ppm, up to about 75 ppm, or up to about 50 ppm.
11. The method of any one of embodiments 1-10, wherein the composition is added to the produced water in a concentration of at least about 10 ppm to about 500 ppm, or at least about 10 ppm to about 100 ppm.
12. The method of any one of embodiments 1-11, wherein the method further comprises combining the produced water with calcium hydroxide, magnesium oxide, sodium carbonate, and/or sodium hydroxide.
13. The method of any one of embodiments 1-12, wherein the produced water is de-oiled prior to combining with the composition.
14. The method of any one of embodiments 1-13, wherein the lime softening is warm lime softening.
15. The method of any one of embodiments 1-13, wherein the lime softening is hot lime softening.
16. The method of any one of embodiments 1-15, wherein the produced water has a pH of from about 8 to about 9.5.
17. The method of any one of embodiments 1-16, wherein turbidity of the produced water after lime softening and removal of the precipitated solids within the produced water is less than about 50 NTU, less than about 25 NTU, or less than about 10 NTU.
18. The method of any one of embodiments 1-16, wherein turbidity of the produced water after lime softening and removal of the precipitated solids within the produced water is less than turbidity achieved by a control coagulant composition at equivalent dosing.
19. The method of any one of embodiments 1-16, wherein turbidity of the produced water after lime softening and removal of the precipitated solids within the produced water is less than or equal to turbidity achieved by a control coagulant composition wherein the coagulant composition is dosed at a concentration that is at least 10 ppm, at least 20 ppm, at least 30 ppm, or at least 40 ppm less than the control coagulant composition.
20. The method of any one of embodiments 18 or 19, wherein the control coagulant composition comprises one of epichlorohydrin dimethyl amine copolymer or dimethylaminoethyl acrylate and one of a polyacrylate or acrylate-acrylamide copolymer.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

In view of the above, it will be seen that the several objects of the invention are achieved and other advantageous results attained.

As various changes could be made in the above methods without departing from the scope of the invention, it is intended that all matter contained in the above description and shown in the accompanying drawing shall be interpreted as illustrative and not in a limiting sense.

What is claimed:

1. A method of treating produced water in a Steam Assisted Gravity Drainage facility comprising:
combining a coagulant composition with a produced water in a Steam Assisted Gravity Drainage prior to lime softening; and
forming precipitated solids within the produced water,
wherein the coagulant composition comprises:
a coagulant polymer comprising at least one of (i) an unreacted polysaccharide component, (ii) a cationic polysaccharide component reacted with a hydrophilic or hydrophobic component, (iii) a tannin, and/or (iv) a chitosan,
at least one additional coagulant comprising an inorganic coagulant and/or an organic coagulant, and
a solvent.

2. The method of claim 1, wherein the polysaccharide component is a starch, alginate, cellulose, dextrin, guar, xanthan, and/or any derivatives thereof.

3. The method of claim 2, wherein the starch is at least one of a corn starch, potato starch, tapioca starch, sago starch, rice starch, wheat starch, waxy maize starch, grain sorghum starch, grain starch, plant starch or combination thereof.

4. The method of claim 1, wherein the coagulant polymer comprises from about 10 wt-% to about 99 wt-% of the composition, the at least one additional coagulant comprises from about 1 wt-% to about 90 wt-% of the composition, and the solvent comprises from about 1 wt-% to about 90 wt-% of the composition.

5. The method of claim 1, wherein the inorganic coagulant comprises aluminum or iron salts, and/or wherein the organic coagulant comprises polyamines, polyquaternized polymers, poly(diallylmethyl ammonium chloride (polyDADMAC), EPIDMA, or combinations thereof.

6. The method of claim 1, wherein the coagulant composition further comprises a flocculant comprising an anionic and/or nonionic emulsion polymers.

7. The method of claim 6, wherein the flocculant is an acrylamide copolymer, polyacrylate and/or a modified polyacrylate.

8. The method of claim 1, wherein the solvent comprises water.

9. The method of claim 1, wherein the method further comprises filtering the precipitated solids to form a treated water.

10. The method of claim 1, wherein the composition is added to the produced water in a concentration of up to about 500 ppm, up to about 250 ppm, up to about 100 ppm, up to about 75 ppm, or up to about 50 ppm.

11. The method of claim 1, wherein the composition is added to the produced water in a concentration of at least about 10 ppm to about 500 ppm, or at least about 10 ppm to about 100 ppm.

12. The method of claim 1, wherein the method further comprises combining the produced water with calcium hydroxide, magnesium oxide, sodium carbonate, and/or sodium hydroxide.

13. The method of claim 1, wherein the produced water is de-oiled prior to combining with the composition.

14. The method of claim 1, wherein the lime softening is warm lime softening.

15. The method of claim 1, wherein the lime softening is hot lime softening.

16. The method of claim 1, wherein the produced water has a pH of from about 8 to about 9.5.

17. The method of claim 1, wherein turbidity of the produced water after lime softening and removal of the precipitated solids within the produced water is less than about 50 NTU, less than about 25 NTU, or less than about 10 NTU.

18. The method of claim 1, wherein turbidity of the produced water after lime softening and removal of the precipitated solids within the produced water is less than turbidity achieved by a control coagulant composition at equivalent dosing.

19. The method of claim 1, wherein turbidity of the produced water after lime softening and removal of the precipitated solids within the produced water is less than or equal to turbidity achieved by a control coagulant composition wherein the coagulant composition is dosed at a concentration that is at least 10 ppm, at least 20 ppm, at least 30 ppm, or at least 40 ppm less than the control coagulant composition.

20. The method of claim 19, wherein the control coagulant composition comprises one of epichlorohydrin dimethyl amine copolymer or dimethylaminoethyl acrylate and one of a polyacrylate or acrylate-acrylamide copolymer.
